(19) United States
(12) Patent Application Publication
(10) Pub. No.: US 2005/0104360 A1
(43) Pub. Date: May 19, 2005

(54) On treatment patient record cover

(75) Inventor: John T. Keane, Framingham, MA (US)

Correspondence Address: David Wolf;Wolf, Greenfield & Sacks, P.C., 600 Atlantic Avenue, Boston, MA, 02210, US

(73) Assignee: Colortrieve Record Systems, Inc., Framingham, MA (US)

(21) Appl. No.: 10/712,811

(22) Filed: Nov. 13, 2003

(51) Int. Cl. B42D 1/00

(52) U.S. Cl. 281/15.1

(57) ABSTRACT

A medical record binder to contain medical records having front and back covers hinged to a spine. A holder for records is coextensive with and is secured to the spine. The holder is formed as a loop having an elongated opening through which medical records may be secured.

### FIELD OF INVENTION

This invention relates to a medical record binder and, more particularly, to a folder designed to retain various medical records including, specifically, X-ray negatives within a durable cover.

### BACKGROUND OF THE INVENTION

Patient medical records are ordinarily voluminous and are maintained on a variety of different-size papers. The paper range of sizes and because X-ray negatives are frequently maintained with these records, there is a unique problem for maintaining medical records in a sensible order, particularly when immediate access to the records and easy indexing is required. For the most part, these records are maintained in cardboard folders which frequently are damaged because of continued use. As a result of the wear and tear resulting from normal usage of these records, medical personnel have used folders made of a very durable plastic material to hold these patient records. For the most part, these folders are made with means for retaining a variety of records within the folder. These means frequently involve the use of metal clasps that are fixed to the folder and provide an engaging feature for holding the records themselves. Typical among these is the medical records folder illustrated in U.S. patent application Ser. No. 08/722,973, filed on Sep. 30, 1996 (now abandoned). While these types of medical record folders are useful and have been used extensively, they have some limitations which the present invention addresses.

One of the concerns with medical records currently commercially available is the cost of manufacturing these binders. Conventionally, binders are made by combining a plastic cover with a metal retainer that is secured to the spine of the binder. These metal retaining elements are made of die-cut metal pieces having relatively sharp edges that may easily damage medical records and, in particular, X-ray film negatives. Additionally, these metal retainers are relatively costly to manufacture since they involve multiple metal components that have to be shaped and interlocked, thus requiring additional labor.

A further limitation in the use and function of currently available medical records is that the retainer used to secure the medical records in binder involves moving parts and assembly. Additionally, these retainers must be opened and closed each time a medical records folder is inserted within the binder.

A still further problem with these medical record folders is the difficulty in properly closing the folder and the likelihood the binder may inadvertently open if it had not been closed properly in the first instance.

A still further concern is these binders and the metal retainer for securing the medical records within the binder are not particularly easy to open or close. Additionally, in currently available medical record binders, the metal retainers project beyond the edges of the binders, thus providing a potential for snagging other records, papers, or otherwise interfering with the easy storage of the binder itself.

These limitations are multiplied when one considers the large volume of medical documents in use at a given time. For example, a radiation department in one hospital, may have several hundred folders at any given time for ready access by medical personnel. These folders are active on particular days when information is both read and inserted into the folder. When used, a great deal of wear and tear on the contents of the folder and the folder, itself occurs. Such use over a period of weeks or months deteriorate the folder. This problem is exacerbated when the folders are stored in binders that themselves present some type of environmental problems or hazard.

### SUMMARY OF INVENTION

The present invention is intended to overcome the problems that are inherent in currently used record binders. In the present invention, a medical record binder is provided that is relatively inexpensive to manufacture, durable and easy to use, and one which may be readily stored without projections or interference with other binders or other medical products or devices.

A further object and advantage of the present invention is to provide an improved medical record binder having no moving parts that readily receives and permanently secured various medical records without any likelihood of damaging the records the binders construction.

A further object of the present invention is to provide an improved medical record binder in which it is easy to insert and remove medical records quickly and efficiently.

In the present invention, there is provided a binder designed specifically for medical records and X-ray negatives. The binder consists of a front panel, a back panel, an intermediate spine formed of a single piece of uniformly thick, durable plastic material with the spine defined from the front and back panels by spaced parallel segments of reduced thickness of the plastic material. The segments defining the spine extend from one to the opposite edge of the binder with the segments defining hinges and the width of the spine defining the thickness of the binder. A holder is formed of a flexible plastic, and is substantially co-extensive with the length of the spine. The holder comprises an elongated member with a back and a loop defined from one another by a line of reduced thickness of the elongated member, extending lengthwise of the member. The loop defining an elongated opening extends the major length of the holder and a width extending laterally of a major portion of the loop. Means are also provided to secure the back to the spine, preferably in the form of a series of rivets that secure the holder directly to the spine.

### BRIEF DESCRIPTION OF DRAWINGS

These and other objects and advantages of the present invention will be more clearly understood when considered in conjunction with the accompanying drawings in which:

FIG. 1 is a perspective view of a binder of the present invention in a closed position lying flat;

FIG. 2 is a perspective view of the binder of the present invention in an open position with the pages of the record contained therein partially open;

FIG. 3 is a cross-sectional view taken substantially along the line 3-3 of FIG. 2 except that the pages of the record are lying flat; and

FIG. 4 is a perspective view of the component of the invention forming the holder.

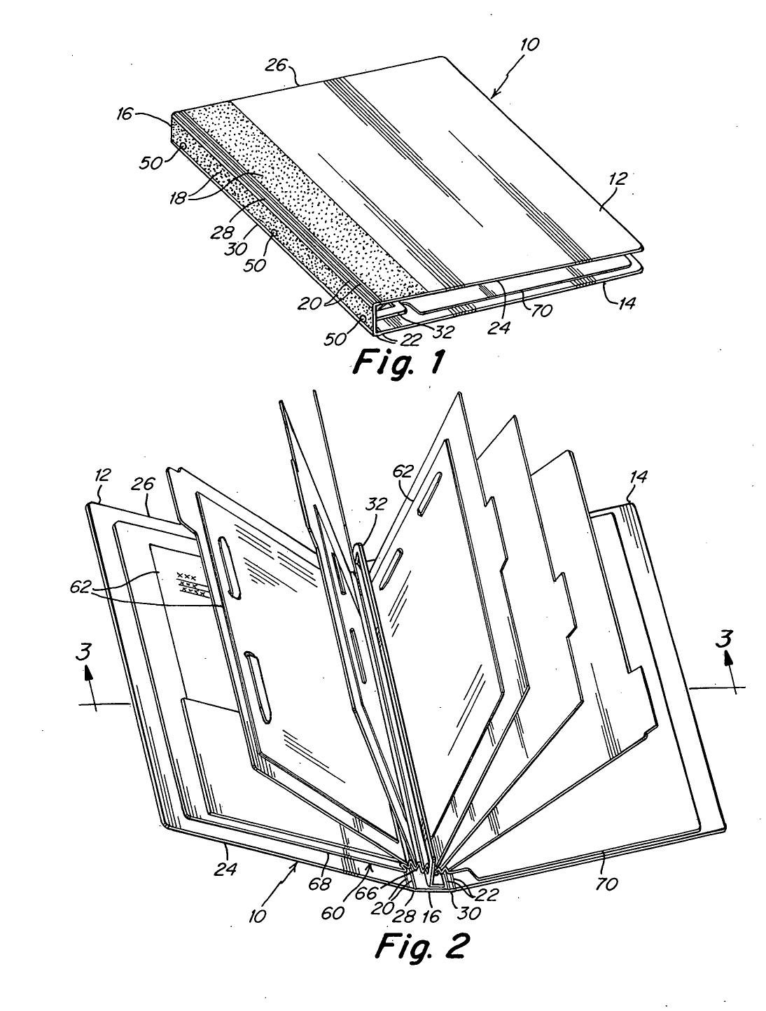

### DETAILED DESCRIPTION OF DRAWINGS

The medical record binder 10 is designed to contain a wide range of medical records and X-ray negatives and comprises a front panel 12, back panel 14, and intermediate spine 16 formed of a single piece of uniformly thick, durable plastic material. The durable cover is intended to protect medical records in the medical record folder from being damaged or destroyed due to heavy use or carelessness. Preferably, the cover may be formed of any suitable plastic material such as a 55-gauge polyethylene. The cover may be opaque or translucent for purposes of seeing names or other information within the binder. Additionally, the binder may be provided with color sections 18 that extend the length of the spine 16 and a portion of the front and back panels 12 and 14. The color portions 18 may vary and be used for color coding information such as identification of divisions, floors, rooms, and the like.

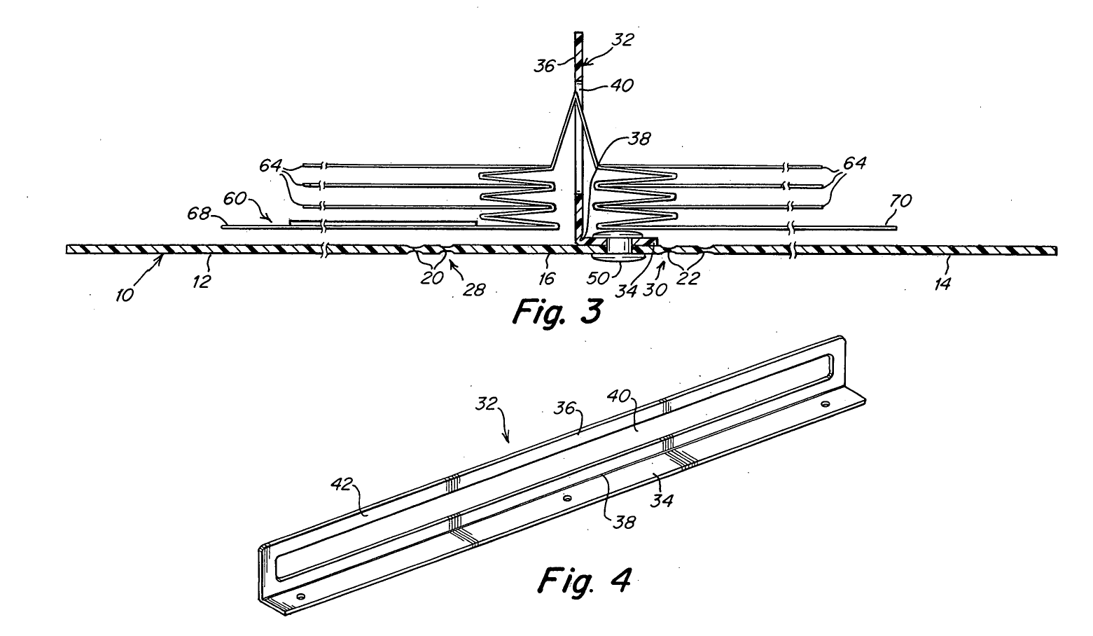

The spine 16 of the binder 10 is defined from the front panel 12 and back panel 14 by spaced parallel segments 20 and 22 of reduced thickness of the plastic material (see FIG. 4). These segments 20, 22 extend from the bottom edge 24 to the top edge 26 of the binder with these reduced thickness segments defining hinges 28 and 30 (FIG. 1). The spaced defined between the segments 20, 22 define the spine 16, and, thus the thickness of the binder. A holder 32 (FIG. 4), formed of flexible plastic is substantially co-extensive with the length of the spine 16. The holder 32 comprises an elongated member of thick plastic which may, for example, be in the order of 55 to 65 gauge polyethylene. The holder 32 is an angularly formed elongated member with one leg forming a back 34 and the other leg forming a loop 36 defined from one another by a hinge or score line 38. The hinge 38 may be defined by a line of reduced thickness of the elongated member 32 with this line extending length-wise of the member 32. The opening defining this loop 36 extends substantially the length of the member 32 as well as almost the width of the loop 36 leaving as large an opening 40 as possible while still retaining a significant structural strength for this loop. In general, for a binder having a height of in the order of 12″, the loop 36 may have an overall width of in the order of 1″ with the periphery 42 of the loop having the width of in the order of ¼″ thus assuring an opening 40 of in the order of at least ½″. As a practical matter, these dimensions may vary considerably depending upon the particular purpose for which the binder is intended and the size of the medical records to be contained in it. The holder 32 is secured to the inner surface of the spine 16 by suitable means which may comprise heat fusion, cement, or preferably a plurality of rivets 50 which project through the spine into and through corresponding openings in the back 34.

The medical record binder is designed to contain a multi-page folder 60 intended to receive and retain medical records and X-ray films 62. The records are contained on retaining sheets or pages 64 that form part of the folder 60. A variety of different type folders may be used including, for example, folders with an accordion-pleated spine 66 of conventional design. In this arrangement, the folder 60 is sized to permit its cover and content to slide through the opening 40 of the loop. The folder 60 is thus positioned with one of its covers 68 on one side and the other cover 70 on the other side of the holder 32 and with the spine of the medical record holder engaging this folder 60. The medical records contained in the folder 60 may be conventional medical records including various care plans, other documents such as agreements relating to patients, X-ray exposures, and the like.

Because the holder 32 is non-moving and permanent, insertion and removal of the medical record folder 60 is easy and does not require any manipulation of releasable components such as has been the case in prior art systems. Additionally, because the holder 32 is formed of plastic and is flexible, there is less likelihood of damage to any of the contents of the medical records folder than might otherwise occur.

1. A medical record binder for medical records and X-ray negatives comprising a front panel, back panel and intermediate spine formed of a single piece of uniformly thick durable plastic material with the spine defined from the front and back panels by spaced parallel segments of reduced thickness of the plastic material, the segments extending from one to the opposite edge of the binder with the segments defining hinges and the width of the spine defining the thickness of the binder, a holder formed of flexible plastic, substantially coextensive with the length of the spine, the holder comprising an elongated member with a back and a loop defined from one another by a line of reduced thickness of the elongated member extending lengthwise of the member, the loop defining an elongated opening extending the major length of the holder and a width extending laterally the major portion of the loop and means securing the back to the spine.

2. A medical record binder as set forth in claim 1 containing a multipage folder for receiving and retaining medical records and X-ray film negatives, the folder positioned with pages on either side of the elongated member and secured by engagement of the folder within the loop.

3. A medical record binder as set forth in claim 2 wherein the means securing the back to the spine comprises a series of rivets extending through and securing the back and spine in fixed facing relation.

4. A medical record binder as set forth in claim 2 wherein the loop extends substantially the length of the holder.
